(19) United States
(12) Patent Application Publication
(10) Pub. No.: US 2002/0045089 A1
(43) Pub. Date: Apr. 18, 2002

(54) Diffusion layer for a fuel cell and a method and apparatus for manufacturing the same

(75) Inventors: Tatsuya Kawahara, Toyota-shi (JP); Katsuhiko Kinoshita, Nisshin-shi (JP); Yoshitaka Kino, Toyota-shi (JP)

Correspondence Address: KENYON & KENYON, Suite 700, 1500 K Street, N.W., Washington, DC, 20005, US

(73) Assignee: TOYOTA JIDOSHA KABUSHIKI KAISHA, Tokyo (JP)

(21) Appl. No.: 09/977,399

(22) Filed: Oct. 16, 2001

(30) Foreign Application Priority Data
Oct. 17, 2000 (JP) 2000-316012

(51) Int. Cl. H01M 4/94; H01M 4/88; B05D 5/12

(52) U.S. Cl. 429/44; 429/42; 502/101; 427/115

(57) ABSTRACT

A method for manufacturing a diffusion layer for a fuel cell including impregnating a synthetic resin binder into a base layer of a woven fabric, and carbonizing the base layer impregnated with the binder. A method for manufacturing a diffusion layer for a fuel cell including carbonizing a base layer of a woven fabric, impregnating a conductive and/or non-conductive synthetic resin into the carbonized base layer, and solidifying the synthetic resin. A method for manufacturing a diffusion layer for a fuel cell, which includes applying a shear force to a paste including carbon and synthetic resin, coating the paste to a base layer, and solidifying the paste.

### FIELD OF THE INVENTION

The present invention relates to a diffusion layer for a fuel cell improved in creep resistance and a method and apparatus for manufacturing the diffusion layer.

### BACKGROUND OF THE INVENTION

A fuel cell (for example, a polymer electrolyte fuel cell) includes a membrane-electrode assembly (MEA), a diffusion layer, and a separator. The MEA includes an electrolyte membrane and a pair of electrodes disposed on opposite sides of the electrolyte membrane. The pair of electrodes include an anode provided on one side of the membrane and constructed of a first catalyst layer and a cathode provided on the other side of the membrane and constructed of a second catalyst layer. A first diffusion layer is provided between the first catalyst layer and the separator, and a second diffusion layer is provided between the second catalyst layer and the separator. The separator has a passage formed therein for supplying fuel gas (hydrogen) to the anode and a passage formed therein for supplying oxidant gas (oxygen, usually, air) to the cathode. A module is constructed of at least one layer of a fuel cell. A number of modules are layered, and electrical terminals, electrical insulators, and end plates are disposed at opposite ends of the pile of modules to construct a stack of fuel cells. After tightening the stack of fuel cells between the opposite end plates in a fuel cell stacking direction, the end plates are coupled to a fastening member (for example, a tension plate) extending in a fuel cell stacking direction outside the pile of fuel cells by bolts.

In the fuel cell, at the anode, hydrogen is changed to positively charged hydrogen ions (i.e., protons) and electrons. The hydrogen ions move through the electrolyte membrane to the cathode where the hydrogen ions react with supplied oxygen and electrons (which are generated at an anode of the adjacent MEA and move to the cathode of the instant MEA through a separator, or which are generated at an anode of the MEA located at one end of the pile of fuel cells and move to the cathode of the MEA located at the other end of the pile of the fuel cells through an outer electrical circuit) to form water as follows:

At the anode: H₂→2H⁺+2e⁻

At the cathode: 2H⁺+2e⁻+(½)O₂→H₂O

In order for the above reaction to be normally conducted, a contact pressure between the diffusion layer and the separator has to be maintained at an appropriate pressure. To maintain the appropriate pressure, the diffusion layer including a base layer made from a carbon woven fabric or a non-woven carbon paper is unlikely to creep when the diffusion layer receives the stacking force from the fastening member. If an excessive creep is caused in the diffusion layer, (a) in a constant-pressure load condition, a gas diffusion characteristic of the diffusion layer will decrease at a separator-rib contact portion whereby it will become difficult to supply a sufficient amount of oxygen to the cathode and the above reaction will be unlikely to be conducted, and (b) in a constant-span load condition where the span between the end plates is maintained constant, the pressure between the diffusion layer and the separator rib will gradually decrease whereby the contact electrical resistance will increase and the output voltage of the fuel cell will decrease.

Japanese Patent Publication No. HEI 8-7897 discloses an MEA where a diffusion layer which includes a base layer made from short carbon fibers and a water-repellent layer made from carbon powders and water-repellent synthetic resin (polytetrafluoroethylene) coated or impregnated to the base layer, is integrally formed to an electrolyte membrane via a catalyst layer by hot-pressing at 120° C.

However, with the conventional diffusion layer of the fuel cell, there is a problem that a creep resistance of the diffusion layer is insufficient because the carbon powders and the water-repellent synthetic resin do not strongly adhere to the carbon fibers of the base layer. The insufficient creep resistance of the diffusion layer will cause the above-described problems of a decrease in the gas diffusion characteristic and an increase in the contact electric resistance.

### SUMMARY OF THE INVENTION

An object of the present invention is to provide a diffusion layer for a fuel cell improved in creep resistance and a method and apparatus for manufacturing such a diffusion layer.

The above object is performed by the following diffusion layer for a fuel cell and manufacturing method and apparatus therefore.

One embodiment of the present invention comprises a diffusion layer for a fuel cell including a base layer. The base layer includes (a) a carbonized yarn of a woven fabric, and (b) a carbonized binder impregnated into the yarn thereby connecting filaments of the yarn.

Another embodiment of the present invention comprises a method for manufacturing a diffusion layer for a fuel cell including (a) impregnating a base layer constructed of a woven fabric with a synthetic resin binder, and (b) carbonizing the base layer and the binder impregnated into the base layer.

Another embodiment comprises an apparatus for manufacturing a diffusion layer for a fuel cell including (a) a binder impregnation treatment container for containing a dissolved binder to be impregnated into a base layer constructed of a woven fabric, and (b) a carbonizing furnace for carbonizing the base layer and the binder impregnated into the base layer.

Yet another embodiment comprises a diffusion layer for a fuel cell including a base layer. The base layer includes (a) a carbonized yarn constructed of a woven fabric, and (b) a conductive synthetic resin binder impregnated into the carbonized yarn thereby connecting filaments of the yarn. The binder is solidified and non-carbonized.

Another embodiment comprises a method for manufacturing a diffusion layer for a fuel cell including (a) carbonizing a base layer constructed of a woven fabric, (b) impregnating the carbonized base layer with a conductive synthetic resin binder, and (c) solidifying the conductive synthetic resin binder impregnated into the base layer.

A further embodiment comprises an apparatus for manufacturing a diffusion layer for a fuel cell including (a) a carbonizing furnace for carbonizing a base layer constructed of a woven fabric, (b) a binder impregnation treatment container for containing a dissolved conductive synthetic resin binder to be impregnated into the carbonized base layer, and (c) a furnace for solidifying the binder.

Another embodiment includes a diffusion layer for a fuel cell including a base layer having a water-repellent characteristic. The base layer includes (a) a carbonized yarn constructed of a woven fabric, and (b) a non-conductive synthetic resin binder impregnated into the carbonized yarn thereby connecting filaments of the yarn. The binder is solidified and non-carbonized.

Another method for manufacturing a diffusion layer for a fuel cell includes (a) carbonizing a base layer constructed of a woven fabric, (b) impregnating the carbonized base layer with a non-conductive synthetic resin binder selected from a group constructed of fluororesin and silicone resin, and (c) solidifying the non-conductive synthetic resin binder impregnated into the base layer.

Another apparatus for manufacturing a diffusion layer for a fuel cell includes (a) a carbonizing furnace for a base layer constructed of a woven fabric, (b) a binder impregnation treatment container for containing a dissolved non-conductive synthetic resin binder to be impregnated into the carbonized base layer, and (c) a furnace for solidifying the binder.

A further embodiment comprises a diffusion layer for a fuel cell including a base layer. The base layer includes (a) a non-woven carbon paper made from carbon fibers, and (b) a synthetic resin binder impregnated into the carbon paper with a nonuniform distribution in an impregnation amount and carbonized. A first portion of the base layer where a relatively large amount of binder is impregnated constructs a rigid portion of the base layer. A second portion of the base layer where a relatively small amount of binder is impregnated constructs a deformable portion of the base layer.

Another embodiment comprises a method for manufacturing a diffusion layer for a fuel cell including (a) impregnating a base layer of a non-woven carbon paper made from carbon fibers in a wet condition with a synthetic resin binder so that the binder has a nonuniform distribution in an impregnation amount, and (b) carbonizing the binder impregnated into the base layer.

Yet another embodiment comprises an apparatus for manufacturing a diffusion layer for a fuel cell including (a) a synthetic resin binder impregnating device for impregnating a base layer of a non-woven carbon paper made from carbon fibers in a wet condition with a synthetic resin binder so that the binder has a nonuniform distribution in an impregnation amount, and (b) a carbonizing furnace for carbonizing the binder impregnated into the base layer.

Another embodiment comprises a diffusion layer for a fuel cell including a non-woven base layer made in a dry condition and a synthetic resin binder impregnated into an entire range of the base layer. The base layer and the impregnated binder are pressed and then completely carbonized.

Yet another embodiment comprises a method for manufacturing a diffusion layer for a fuel cell including (a) impregnating a non-woven base layer made in a dry condition with a synthetic resin binder, (b) pressing the base layer impregnated with the synthetic resin binder, and (c) completely carbonizing the base layer and the synthetic resin binder impregnated into the base layer.

Yet another embodiment comprises an apparatus for manufacturing a diffusion layer for a fuel cell including (a) a synthetic resin binder impregnating device for impregnating a non-woven base layer made in a dry condition with a synthetic resin binder, (b) a press device for pressing the base layer impregnated with the synthetic resin binder, and (c) a carbonizing furnace for completely carbonizing the base layer and the synthetic resin binder impregnated into the base layer.

Yet another embodiment comprises a diffusion layer for a fuel cell including (a) a base layer having opposite surfaces, and (b) a water-repellent layer made from a mixture of carbon and synthetic resin formed on one surface of the base layer. The water-repellent layer is constructed of a multi-layer structure including an inner layer and an outer layer different in adhesiveness and strength to each other. The inner layer has a strength greater than a strength of the outer layer. The outer layer has an adhesiveness stronger than an adhesiveness of the inner layer.

Yet another embodiment comprises a method for manufacturing a diffusion layer for a fuel cell including repeating a plurality of times a process comprising the steps of coating a layer made from a mixture of carbon and synthetic resin and then solidifying the coated layer. A solidifying condition is different between respective processes.

Another embodiment comprises a method further including (a) coating a first water-repellent layer made from a mixture of carbon and synthetic resin on a carbon base layer and then solidifying the first water-repellent layer at a first temperature higher than a melting temperature of the synthetic resin, and (b) coating a second water-repellent layer made from a mixture of the carbon and the synthetic resin on the first water-repellent layer and then solidifying the second water-repellent layer at a second temperature near the melting temperature of the synthetic resin.

Another embodiment comprises an apparatus for manufacturing a diffusion layer for a fuel cell including a furnace for solidifying a first water-repellent layer made from a mixture of carbon and synthetic resin coated on a carbon base layer at a first temperature higher than a melting temperature of the synthetic resin and for solidifying a second water-repellent layer made from a mixture of the carbon and the synthetic resin coated on the first water-repellent layer at a second temperature near the melting temperature of the synthetic resin.

Another embodiment comprises a diffusion layer for a fuel cell including a water-repellent layer including two kinds of binders.

Another embodiment comprises a diffusion layer for a fuel cell , wherein the two kinds of binders include a first binder made from a synthetic resin having an adhesiveness and a second binder made from material having a higher rigidness than the synthetic resin of the first binder.

Another embodiment comprises a method for manufacturing a water-repellent layer of a diffusion layer for a fuel cell including (a) coating a mixture of carbon and two kinds of binders dissolved in solvent on a base layer of the diffusion layer, and (b) solidifying the mixture coated on the base layer at a temperature near a melting temperature of one of the binders.

Another embodiment comprises a method that further includes (a) coating the mixture including the two kinds of binders on the base layer of the diffusion layer, wherein the two kinds of binders include a first binder made from a synthetic resin having an adhesiveness and a second binder made from material having a greater rigidness than the first binder, and (b) solidifying the mixture coated on the base layer at a temperature near a melting temperature of the first binder.

Another embodiment comprises an apparatus for manufacturing a diffusion layer for a fuel cell including a furnace for solidifying a water-repellent layer made from a mixture of carbon and two kinds of binders and coated on a base layer of the diffusion layer at a temperature near a melting temperature of one of the two kinds of binders.

Yet another embodiment comprises a diffusion layer for a fuel cell including (a) a base layer, and (b) a water-repellent layer coated on the base layer. The water-repellent layer is made from a mixture of carbon and synthetic resin and solidified. The synthetic resin is deformed into filaments by applying a shear force to the mixture before coating of the mixture onto the base layer.

Another embodiment comprises a method for manufacturing a diffusion layer for a fuel cell including (a) applying a shear force to a paste including carbon and synthetic resin, (b) coating the paste on a base layer of the diffusion layer, and (c) solidifying the paste coated on the base layer at a temperature near a melting temperature of the synthetic resin.

Yet another embodiment comprises an apparatus for manufacturing a diffusion layer for a fuel cell including (a) a mixer for applying a shear force to a paste including carbon and synthetic resin, (b) a coating device for coating the paste on a base layer of the diffusion layer, and (c) a furnace for solidifying the paste coated on the base layer at a temperature near a melting temperature of the synthetic resin.

Another embodiment comprises a diffusion layer for a fuel cell including (a) a base layer, and (b) a water-repellent layer coated on the base layer. The water-repellent layer is made from a mixture of carbon and synthetic resin and solidified. The synthetic resin is deformed into filaments by applying a shear force to the water-repellent layer after solidifying the water-repellent layer.

Another embodiment comprises a method for manufacturing a diffusion layer for a fuel cell including (a) coating a paste including carbon and synthetic resin for a water-repellent layer on a base layer of the diffusion layer, (b) solidifying the paste coated on the base layer at a temperature near a melting temperature of the synthetic resin, and (c) applying a shear force to the water-repellent layer by causing the base layer and the water repellent layer to pass between a pair of rollers which generate a stress directed in a width direction of the base layer in the water-repellent layer.

Yet another embodiment comprises an apparatus for manufacturing a diffusion layer for a fuel cell including (a) a coating device for coating a paste including carbon and synthetic resin on a base layer of the diffusion layer, (b) a furnace for solidifying the paste coated on the base layer at a temperature near a melting temperature of the synthetic resin, and (c) a pair of rollers for applying a shear force to the paste solidified when the solidified paste and the base layer are caused to pass between the pair of rollers.

As described above, the present invention includes embodiments that improve the creep resistance of the diffusion larger due to an increase in only either one of the base layer and the water-repellent layer.

More, particularly, the present invention provides embodiments that improve the creep resistance of the diffusion layer due to an increase in strength of the base layer only. The present invention also includes embodiments, which include impregnating a binder containing synthetic resin to the base layer and solidifying the synthetic resin thereby increasing the strength of the base layer only and improving the creep resistance of the diffusion layer.

The present invention also provides embodiments that improve the creep resistance of the diffusion layer due to an increase in strength of the water-repellent layer only. The above embodiments further include increasing the strength of the water-repellent layer by, for example, deforming the synthetic resin particles into filaments, and improving the creep resistance of the diffusion layer.

By increasing the strength of only either one of the base layer and the water-repellent layer, the creep resistance of the diffusion layer can be improved without degrading a gas diffusion characteristic of the diffusion layer.

The following technical advantages can be obtained from the present invention.

First, since the base layer constructed of a woven fabric is impregnated with a synthetic resin binder, the filaments of the yarn are fastened to each other by the added binder and the strength of the yarn is increased so that the creep resistance of the base layer of the diffusion layer is improved. Furthermore, since the base layer and the binder impregnated into the base layer are carbonized, the entire portion of the diffusion layer is carbonized so that the electrical conductivity of the diffusion layer is increased.

Second, since the carbonized base layer is impregnated with a conductive synthetic resin binder (for example, thermoplastic resin or thermosetting resin mixed with carbon black), the filaments of the yarn are fastened to each other by the added binder and the strength of the yarn is increased so that the creep resistance of the base layer of the diffusion layer is improved. Furthermore, since the conductive synthetic resin binder is not carbonized, the conductivity may be inferior to that of the diffusion layer of the above (1)-(3), but there is a benefit that the diffusion layer can be manufactured by treating a conventional carbonized woven fabric.

Third, since the carbonized base layer is impregnated with a non-conductive synthetic resin binder (for example, fluororesin and silicone resin and the non-conductive synthetic resin binder is solidified, the filaments of the yarn are fastened to each other by the added binder and the strength of the yarn is increased so that the creep resistance of the base layer of the diffusion layer is improved. Furthermore, since the synthetic resin binder is not carbonized, there is no benefit of an increase in conductivity, but there may be a benefit in that the water resistance of the diffusion layer can be improved by providing the yarn with a water-repellent characteristic and that the diffusion layer can be manufactured by treating a conventional carbonized woven fabric.

Fourth, since the base layer of a non-woven carbon paper made from carbon fibers in a wet condition is impregnated with a synthetic resin binder, the creep resistance of the base layer of the diffusion layer is improved by the added binder. Furthermore, since the binder has a nonuniform distribution in an impregnation amount (for example, in a spline pattern), non-impregnated or little impregnated portions of the diffusion layer have flexibility so that the diffusion layer can be wound into a roll and manufacturing of a continuous diffusion layer is possible. Furthermore, since the base layer is carbonized after impregnation of the binder, an entire portion of the base layer has conductivity.

Fifth, since the non-woven base layer made in a dry condition is impregnated with a synthetic resin binder, then is pressed, and then is completely carbonized, the creep resistance of the base layer of the diffusion layer is improved due to the addition of the binder and pressing. Furthermore, since the base layer is carbonized after impregnation of the binder, an entire portion of the base layer has conductivity.

Sixth, since the water-repellent layer made from carbon and synthetic resin (for example, polytetrafluoroethylene) includes two layers and the first layer is solidified at a first temperature higher than a melting temperature of the synthetic resin, the first layer has a large rigidness so that the creep resistance of the water-repellent layer of the diffusion layer is improved. Furthermore, since the second layer is coated on the first layer and the second layer is solidified at a second temperature near the melting temperature of the synthetic resin, when a load is added from outside, the synthetic resin can be deformed into filaments by a shear force to form an adhesive layer at the surface of the diffusion layer so that an adhesiveness of the diffusion layer to a catalyst layer of the MEA will be increased. In a case where a diffusion layer is constructed of a single layer, it is difficult to obtain both of a creep resistance of the water-repellent layer and an adhesiveness of the water-repellent layer to the catalyst layer. However, in the present invention, since the water-repellent layer includes two layers and the solidifying temperatures for the two layers are different from each other, it becomes possible to obtain both improved creep resistance and improved adhesiveness of the water-repellent layer.

Seventh, since a mixture of carbon and two kinds of binders which include a first binder made from a synthetic resin having an adhesiveness and a second binder made from material having a greater rigidness than the first binder, is coated on a base layer of the diffusion layer and is solidified, the strength of the water-repellent layer can be increased due to the addition of the second binder so that the creep resistance of the water-repellent layer can be improved.

Eighth, since a shear force is applied to a paste including carbon and synthetic resin (for example, polytetrafluoroethylene), the synthetic resin may be deformed into filaments by the shear force in order to increase the binding force of the binder so that the strength of the water-repellent layer is increased and the creep resistance of the diffusion layer is improved.

Finally, since a shear force is applied to the solidified water-repellent layer by causing the base layer and the water-repellent layer to pass between a pair of rollers which generate stress directed across the width of the base layer in the water-repellent layer, the synthetic resin may be deformed into filaments by the shear force in order to increase the binding force of the binder so that the strength of the water-repellent layer is increased and the creep resistance of the diffusion layer is improved.

### BRIEF DESCRIPTION OF THE DRAWINGS

The above and other objects, features, and advantages of the present invention will become apparent and will be more readily appreciated from the following detailed description of the preferred embodiments of the present invention in conjunction with the accompanying drawings.

FIG. 1 is an enlarged cross-sectional view of a diffusion layer according to the present invention.

FIG. 2 is an enlarged cross-sectional view of a yarn deformed by a load of the diffusion layer according to the present invention and of a yarn deformed by a load of a comparison diffusion layer.

FIG. 3 is a schematic view illustrating an embodiment of a method for manufacturing a diffusion layer according to the present invention.

FIG. 4 is a schematic view illustrating another embodiment of a method for manufacturing a diffusion layer according to the present invention.

FIG. 5 is a schematic view illustrating yet another embodiment of a method for manufacturing the diffusion layer according to the present invention.

FIG. 6 is a graph illustrating a change of an internal electric resistance in a constant-span load condition, applicable to the present invention.

FIG. 7 is a schematic view illustrating of a method for manufacturing a diffusion layer according to an embodiment of the present invention.

FIG. 8 is an enlarged cross-sectional view of a diffusion layer of the present invention.

FIG. 9 is a schematic view illustrating of a method for manufacturing a diffusion layer according to of the present invention.

FIG. 10 is a schematic view illustrating of a method for manufacturing a diffusion layer according to the present invention.

FIG. 11 illustrates the structure of a diffusion layer according to the present invention.

FIG. 12 is a side view of an apparatus for manufacturing a diffusion layer according to the present invention.

FIG. 13 is a side view of an apparatus for manufacturing a diffusion layer according to the present invention.

FIG. 14 is a front view of an apparatus for manufacturing a diffusion layer according to the present invention.

FIG. 15 is a front view of a fuel cell in which the diffusion layer is assembled according to the present invention.

FIG. 16 is an enlarged cross-sectional view of a portion of a module of the fuel cell of FIG. 15.

### DEATILED DESCRIPTION

A diffusion layer manufactured by a method and apparatus according to the present invention may be used for a fuel cell 10 (for example, a polymer electrolyte fuel cell). The fuel cell 10 may be mounted to, for example, a vehicle. However, the fuel cell 10 may be used for other purposes than for a vehicle.

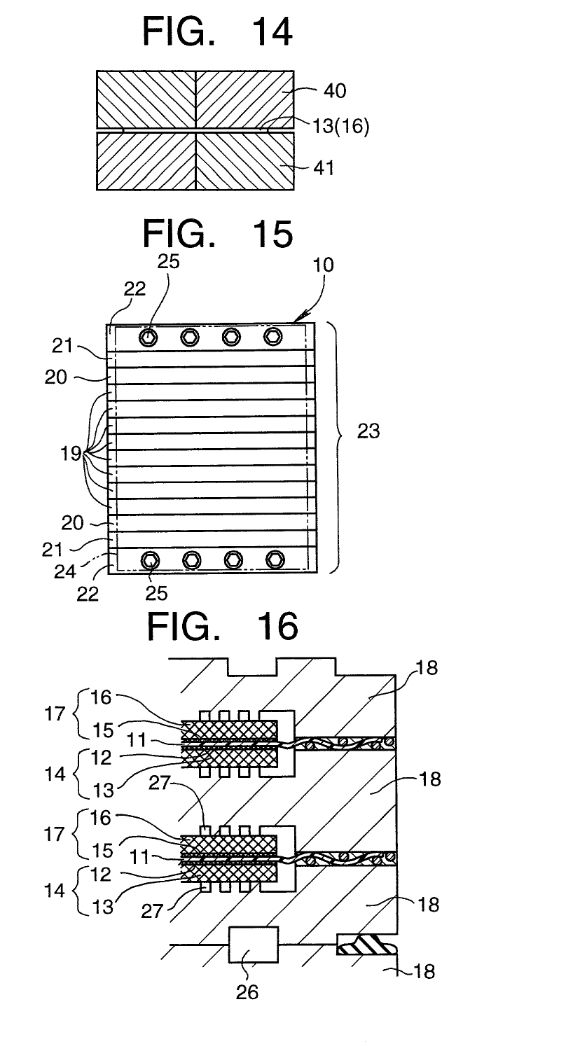

As illustrated in FIGS. 15, 16 and 1, the polymer electrolyte fuel cell 10 can include a membrane-electrode assembly (MEA), a diffusion layer, and a separator. The MEA can include an electrolyte membrane 11 and a pair of electrodes 14, 17 disposed on opposite sides of the electrolyte membrane 11. The pair of electrodes 14, 17 can include an anode 14 provided on one side of the membrane 11 and constructed of a first catalyst layer 12 and a cathode 17 provided on the other side of the membrane 11 and constructed of a second catalyst layer 15. A first diffusion layer 13 may be provided between the first catalyst layer 12 and the separator 18, and a second diffusion layer 16 may be provided between the second catalyst layer 15 and the separator 18. The separator 18 has a passage 27 formed therein for supplying fuel gas (hydrogen) to the anode 14 and a passage 27 formed therein for supplying oxidant gas (oxygen, usually, air) to the cathode 17. A module 19 is constructed of at least one layer of fuel cells. A number of modules 19 can be layered together, and electrical terminals 20, electrical insulators 21, and end plates 22 can be disposed at opposite ends of the pile of modules to construct a stack 23 of fuel cells. After tightening the stack 23 of fuel cells between the opposite end plates 22 in a fuel cell stacking direction, the end plates 22 can be coupled to a fastening member 24 (for example, a tension plate) extending in a fuel cell stacking direction outside the pile of fuel cells by bolts 25.

Each catalyst layer 12, 15 can have the same structure and include carbon (C) carrying platinum (Pt). Each catalyst layer 12, 15 may include electrolyte.

Each diffusion layer 13, 16 can have the same structure and can be made from carbon (C). As illustrated in FIG. 1, each diffusion layer 13, 16 includes a water-repellent layer 13a, 16a and a base layer 13b, 16b. The water repellent-layer 13a, 16a is coated on the base layer 13b, 16b. The water-repellent layer 13a, 16a can include carbon powder 28 (the power may be particles, and the carbon power can be, for example, carbon black) and a binder for binding the carbon powder. The binder can be made from synthetic resin (for example, fluororesin such as polytetrafluoroethylene). Each base layer 13b, 16b is located closer to the separator 18 than each water-repellent layer 13a, 16a. Each water-repellent layer 13a, 16a and each base layer 13b, 16b has permeability so that hydrogen and air can reach the catalyst layer 12, 15. Each water-repellent layer 13a, 16a can be provided with more water repellent than each base layer 13b, 16b. A thickness of each diffusion layer 13, 16 is about 200 μm. A thickness of each water-repellent layer 13a, 16a is about 50 μm, and a thickness of each base layer 13b, 16b is about 150 μm.

The separator 18 can be non-permeable with respect to gas and water, and has an electric conductivity. The separator 18 can be made from carbon, metal, or synthetic resin and a given conductivity can be achieved by mixing the resin with conductive particles or fibers such as carbon black (or graphite). The separator 18 operates to separate the hydrogen and the air from each other, to separate the hydrogen and cooling water from each other, and to separate the air and cooling water from each other. The separator 18 operates also as an electric current passage between the individual cells connected in series.

In manufacturing of the diffusion layer 13, 16, it is important that the diffusion layer 13, 16 has a creep resistance. This is because if a creep is caused in the diffusion layer 13, 16, in the constant-pressure load condition, the gas diffusion will decrease at the contact portion of the diffusion layer with the separator rib (a convex portion between grooves for the flow passages), and in the constant-span load condition where the span between the end plates are maintained constant, the contact pressure will decrease thereby increasing the contact electric resistance.

In order to improve the creep resistance of the diffusion layer 13, 16, only either one of the base layer 16b, 16b and the water-repellent layer 13a, 16a is increased in strength. Only the base layer 13b, 16b may be increased in strength when the diffusion layer 13, 16 includes at least the base layer 13b, 16b, and only the water-repellent layer 13a, 16a may be increased in strength when the diffusion layer 13, 16 includes the base layer 13b, 16b and the water-repellent layer 13a, 16a.

A method for manufacturing the diffusion layer 13, 16 includes the step of providing at least a base layer 13b, 16b, wherein the base layer 13b, 16b is increased in strength. The method may include the steps of providing a base layer 13b, 16b and coating a water-repellent layer 13a, 16a on the base layer 13b, 16b, wherein during only either one of the base layer providing step and the water-repellent layer coating step, the respective one of the base layer 13b, 16b and the water-repellent layer 13a, 16a is increased in strength.

An apparatus for manufacturing the diffusion layer 13, 16 includes a device for providing at least a base layer 13b, 16b, wherein the base layer 13b, 16b only is increased in strength by the device. The apparatus may include a first device for providing a base layer 13b, 16b and a second device for coating a water-repellent layer 13a, 16a on the base layer 13b, 16b, wherein only either one of the base layer 13b, 16b and the water-repellent layer 13a, 16a is increased in strength by the respective one of the first device and the second device.

Next, a diffusion layer 13, 16 and a method and apparatus for manufacturing the diffusion layer 13, 16 according to several example embodiments of the present invention will be explained.

First Embodiment

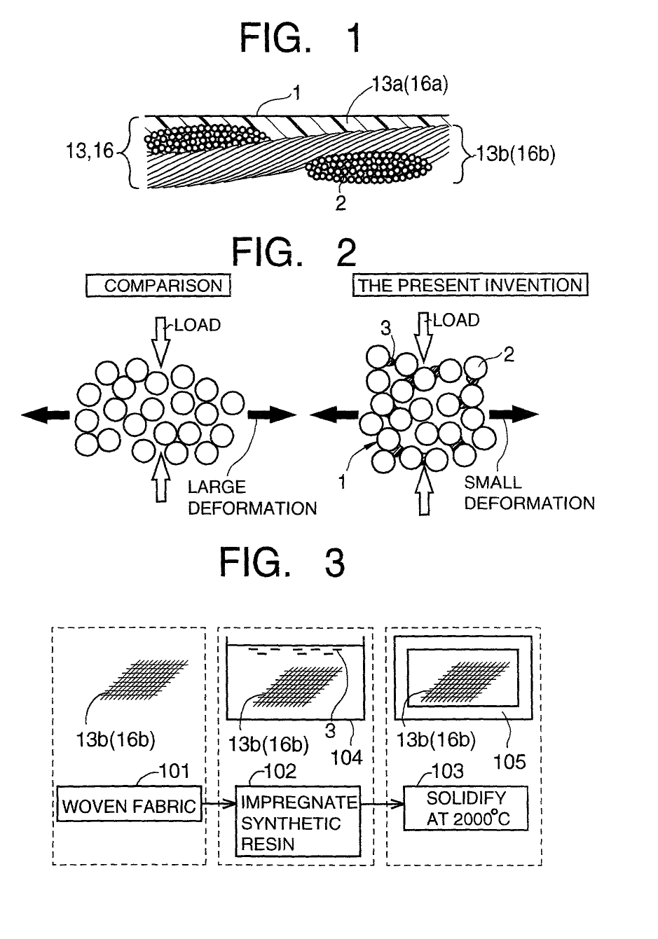

As illustrated in FIGS. 1 and 2, the diffusion layer 13, 16 for the fuel cell according to the first embodiment of the present invention includes a base layer 13b, 16b. The base layer 13b, 16b includes (a) a yarn 1 (constructed of stranded filaments 2) of a carbonized woven fabric and (b) a carbonized binder 3 impregnated into the yarn (impregnated between the filaments 2) thereby connecting filaments 2 of the yarn.

FIGS. 1-3, illustrate a method for manufacturing the diffusion layer 13, 16 for a fuel cell according to the first embodiment of the present invention including a method for creep resistance of the base layer 13b, 16b. The method includes: making a woven fabric as a precursor from non-carbonized fibers or incompletely carbonized fibers at step 101 in FIG. 3, impregnating a base layer 13b, 16b constructed of the woven fabric with a dissolved binder 3 (liquid or slurry) made from synthetic resin such as fluororesin or phenolic resin at step 102, and carbonizing the base layer 13b, 16b and the binder 3 impregnated into the base layer at step 103. The binder includes carbon powder. When the binder is impregnated into the base layer 13b, 16b, a layer which becomes water-repellent after being carbonized is formed at the surface of the base layer 13b, 16b. The carbonizing at step 103 is conducted at about 2,000.

As illustrated in FIG. 3, an apparatus for manufacturing a diffusion layer for a fuel cell according to the first embodiment of the present invention includes (a) a binder impregnation treatment container 104 containing a dissolved binder 3 (liquid or slurry) to be impregnated into a base layer 13b, 16b constructed of a woven fabric, and (b) a carbonizing furnace 105 for carbonizing the base layer 13b, 16b and the binder 3 impregnated into the base layer.

In the first embodiment of the present invention, since the base layer 13b, 16b constructed of a woven fabric is impregnated with the binder 3, the filaments 2 of the yarn 1 are fastened to each other by the added binder and the strength of the yarn 1 is increased so that the creep resistance of the base layer 13b, 16b of the diffusion layer 13, 16 is improved. FIG. 2 illustrates the reason for the increase in the strength of the yarn and the improvement in the creep resistance of the base layer. As illustrated in the left half of FIG. 2 which illustrates a conventional case, when the stack is tightened and a load acts on the yarn, the yarn is deformed in a direction perpendicular to the load direction because there is little restriction between filaments, and the creep amount is large. In contrast, in the present invention, as illustrated in a right half of FIG. 2, when the stack is tightened and a load acts on the yarn 1, the yarn is little deformed in a direction perpendicular to the load direction because the filaments are restricted by the binder 3 and are carbonized maintaining the restricted condition, and the creep amount is small.

FIG. 6 illustrates the increase in the electric resistance due to the decrease in the contact pressure in the constant-span load condition where the span between the end plates is maintained constant. As seen from FIG. 6, the increase in the electric resistance in the case of the first embodiment of the present invention is smaller than that of the conventional case, and the creep resistance is improved.

Furthermore, since the base layer and the binder impregnated into the base layer are carbonized, the entire portion of the diffusion layer 13, 16 is carbonized so that the electrical conductivity of the diffusion layer 13, 16 is increased.

Second Embodiment

As illustrated in FIGS. 1 and 2, the diffusion layer 13, 16 for the fuel cell according to the second embodiment of the present invention includes a base layer 13b, 16b. The base layer 13b, 16b includes (a) a yarn 1 (constructed of stranded filaments 2) of a woven fabric and carbonized, and (b) a conductive synthetic resin binder 3 impregnated into the yarn (impregnated between the filaments 2) thereby connecting filaments 2 of the yarn and solidified but not carbonized.

As illustrated in FIGS. 1, 2 and 4, a method for manufacturing the diffusion layer 13, 16 for a fuel cell according to the second embodiment of the present invention includes: carbonizing a base layer 13b, 16b constructed of a woven fabric at about 2,000° C. at step 201, impregnating the carbonized base layer 13b, 16b with a conductive synthetic resin binder 3 at step 202, and solidifying the conductive synthetic resin binder impregnated into the base layer 13b, 16b at the solidifying temperature of the synthetic resin (for example, about 320° C.) at step 203. The conductive synthetic resin used at step 202 is resin solidified by reaction or thermosetting resin containing carbon black. For example, phenolic resin mixed with carbon black is used for the conductive synthetic resin. The solidifying of the synthetic resin at step 203 includes heating the synthetic resin to the melting temperature of the resin and then cooling to solidify it. The solidifying of the synthetic resin at step 203 is conducted at a temperature below 350° C. and is not carbonizing.

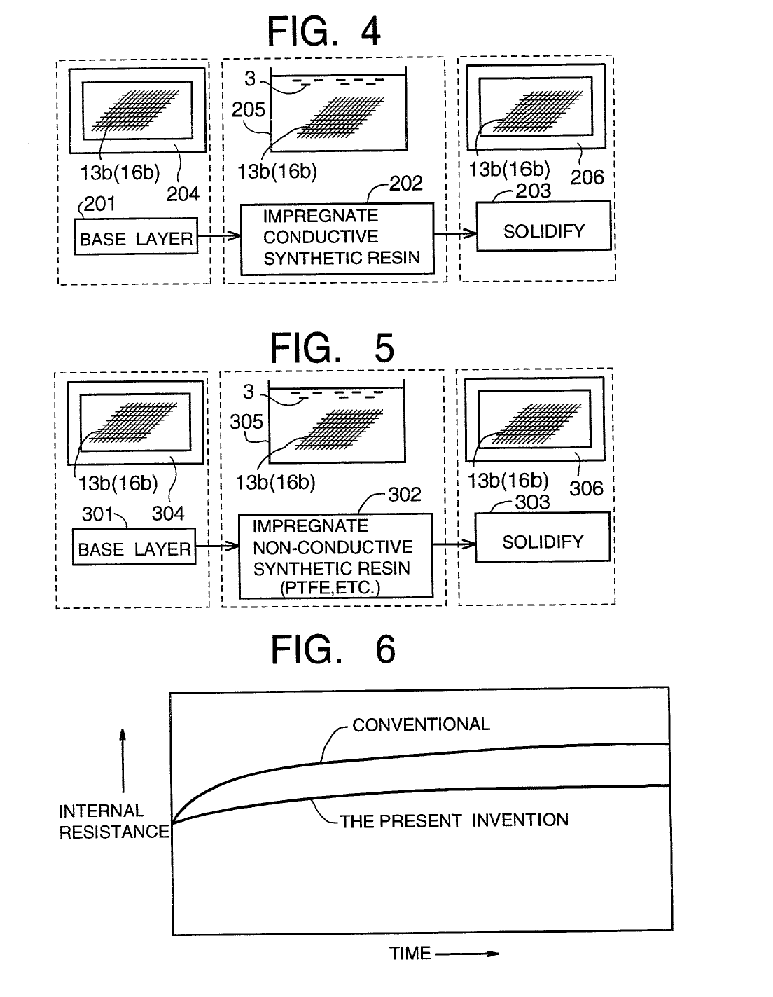

As illustrated in FIG. 4, an apparatus for manufacturing a diffusion layer for a fuel cell according to the second embodiment of the present invention includes (a) a carbonizing furnace 204 for carbonizing a base layer 13b, 16b constructed of a woven fabric, (b) a binder impregnation treatment container 205 containing a dissolved conductive synthetic resin binder 3 (liquid or slurry) to be impregnated into the carbonized base layer 13b, 16b, and (c) a furnace 206 for solidifying the binder 3 at a solidifying temperature of the binder synthetic resin (at about 320° C.).

In the second embodiment of the present invention, the base layer 13b, 16b is firstly carbonized, and after carbonizing, the conductive synthetic resin is impregnated. Therefore, the synthetic resin is not carbonized. Due to the binder synthetic resin, the strength of the yarn 1 of the carbonized base layer 13b, 16b is increased so that the creep resistance of the base layer 13b, 16b of the diffusion layer is improved. The reason for the increase in the strength of the yarn 1 and the improvement of the creep resistance explained in the first embodiment using FIG. 2 can be applied to the second embodiment also. As illustrated in FIG. 6, an increase in the internal electric resistance of the fuel cell is suppressed in the second embodiment like in the first embodiment. Furthermore, since the conductive synthetic resin binder is not carbonized, the conductivity of the diffusion layer may be inferior to that of the diffusion layer of the first embodiment where the entire portion of the diffusion layer is carbonized, but there is an advantage in the second embodiment that the diffusion layer can be manufactured by using and treating a conventional carbonized woven fabric.

Third Embodiment

As illustrated in FIGS. 1 and 2, the diffusion layer 13, 16 for the fuel cell according to the third embodiment of the present invention includes a base layer 13b, 16b. The base layer 13b, 16b includes (a) a yarn 1 (constructed of stranded filaments 2) of a woven fabric and carbonized, and (b) a non-conductive synthetic resin binder 3 impregnated into the yarn (impregnated between the filaments 2) thereby connecting filaments 2 of the yarn and solidified but not-carbonized.

As illustrated in FIGS. 1, 2 and 5, a method for manufacturing the diffusion layer 13, 16 for a fuel cell according to the third embodiment of the present invention includes: carbonizing a base layer 13b, 16b constructed of a woven fabric at about 2,000° C. at step 301, impregnating the carbonized base layer 13b, 16b with a non-conductive synthetic resin binder 3 selected from the group constructed of fluororesin (for example, PTFE (polytetrafluoroethylene), PVDF, ETFE) and silicone resin, dissolved in solvent at step 302, and solidifying the non-conductive synthetic resin binder impregnated into the base layer 13b, 16b at the solidifying temperature of the synthetic resin at step 303. The solidifying of the synthetic resin at step 303 includes heating the synthetic resin to the melting temperature of the resin and then cooling to solidify it. The solidifying of the synthetic resin at step 303 is conducted at a temperature below 300° C. and is not carbonizing.

As illustrated in FIG. 5, an apparatus for manufacturing a diffusion layer for a fuel cell according to the third embodiment of the present invention includes (a) a carbonizing furnace 204 for carbonizing a base layer 13b, 16b constructed of a woven fabric at about 2,000° C., (b) a binder impregnation treatment container 305 containing a dissolved non-conductive synthetic resin binder 3 (liquid or slurry) to be impregnated into the carbonized base layer 13b, 16b, and (c) a furnace 306 for solidifying the binder 3 at a solidifying temperature of the binder synthetic resin (at about 320° C.).

In the third embodiment of the present invention, the base layer 13b, 16b is firstly carbonized, and after carbonizing, the non-conductive synthetic resin is impregnated. Therefore, the synthetic resin is not carbonized. Due to the binder synthetic resin, the strength of the yarn 1 of the carbonized base layer 13b, 16b is increased so that the creep resistance of the base layer 13b, 16b of the diffusion layer is improved. The reason for the increase in the strength of the yarn 1 and the improvement of the creep resistance explained in the first embodiment using FIG. 2 can be applied to the third embodiment also. Furthermore, since the non-conductive synthetic resin binder is not carbonized, there is no benefit of an increase in conductivity in the third embodiment unlike the first embodiment, but there is an advantage in the third embodiment that the diffusion layer can be manufactured by using and treating a conventional carbonized woven fabric. Furthermore, by using a synthetic resin having water repellent for the binder 3, the water repellent of the diffusion layer can be increased. Furthermore, as illustrated in FIG. 6, an increase in the internal electric resistance of the fuel cell is suppressed in the third embodiment similar to the first embodiment.

Fourth Embodiment

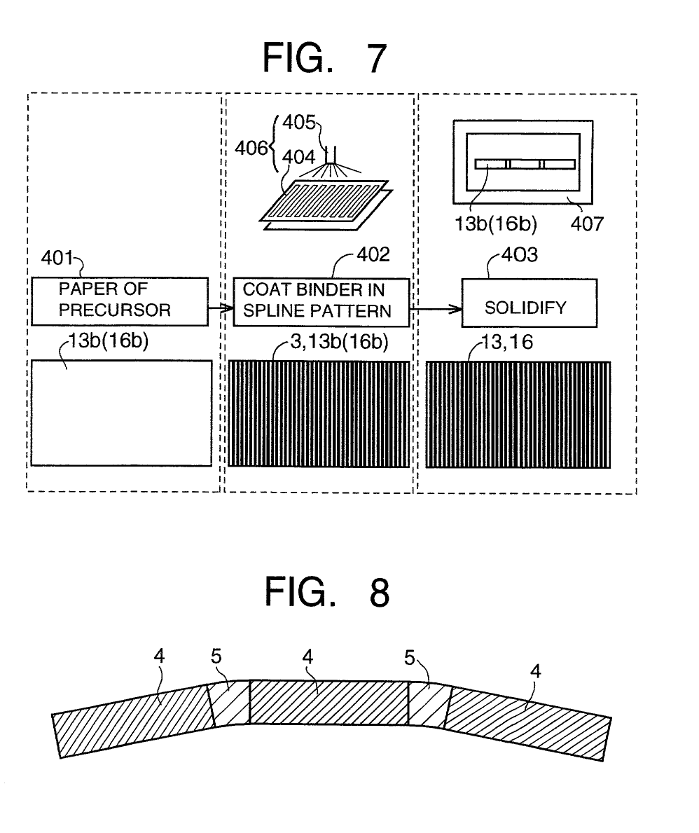

As illustrated in FIGS. 7 and 8, the diffusion layer 13, 16 for the fuel cell according to the fourth embodiment of the present invention includes a base layer 13b, 16b. The base layer 13b, 16b includes (a) a non-woven carbon paper made from carbon fibers, and (b) a synthetic resin binder impregnated into the carbon paper with a nonuniform distribution (for example, in the pattern of a spline) in an impregnation amount and carbonized. A first portion of the base layer where a relatively large amount of binder is impregnated constructs a rigid portion 4 of the base layer and a second portion of the base layer where a relatively small amount of binder is impregnated constructs a deformable portion 5 of the base layer. When the base layer is wound around a roller, the deformable portion 5 extends in a direction perpendicular to an axis of curvature so that winding of the diffusion layer to the roller is possible.

As illustrated in FIGS. 7 and 8, a method for manufacturing the diffusion layer 13, 16 for a fuel cell according to the fourth embodiment of the present invention includes: manufacturing a non-woven carbon paper (base layer 13b, 16b) from carbon fibers in a wet condition at step 401, impregnating the base layer 13b, 16b with a synthetic resin binder 3 so that the binder 3 has a nonuniform distribution in an impregnation amount at step 402, and carbonizing the binder impregnated into the base layer at step 403.

As illustrated in FIG. 7, an apparatus for manufacturing the diffusion layer 13, 16 for a fuel cell according to the fourth embodiment of the present invention includes (a) a synthetic resin binder impregnating device 406 for impregnating the base layer 13b, 16b of a non-woven carbon paper made from carbon fibers in a wet condition with a synthetic resin binder 3 so that the binder 3 has a nonuniform distribution in an impregnation amount, and (b) a carbonizing furnace 407 for carbonizing the binder 3 impregnated into the base layer 13b, 16b.

In the fourth embodiment of the present invention, the amount of the binder is minimal at step 401. At step 402, the binder synthetic resin is impregnated, for example, in the pattern of a spline. This can be conducted, for example, by disposing a mask 404 having a plurality of parallel slits above the carbon paper and spraying the binder synthetic resin, or by coating the binder using a coating robot, or by coating the binder by screen printing. After impregnating the binder, the binder is carbonized. As illustrated in FIG. 8, the portion impregnated with the binder is increased in rigidness to form the rigid portion 4 and increases the creep resistance, while the portion minimally or not impregnated with the binder forms a flexible or deformable portion 5.

Due to the flexible portion 5, the carbonized carbon paper can be wound in the direction perpendicular to the spline of the binder and can be wound to a roller, so that continuous production of the diffusion layer is possible. As a result, both improvement of creep resistance and effective production are obtained. Furthermore, as illustrated in FIG. 6, an increase in the internal electric resistance of the fuel cell is suppressed in the fourth embodiment similar to the first embodiment.

Fifth Embodiment

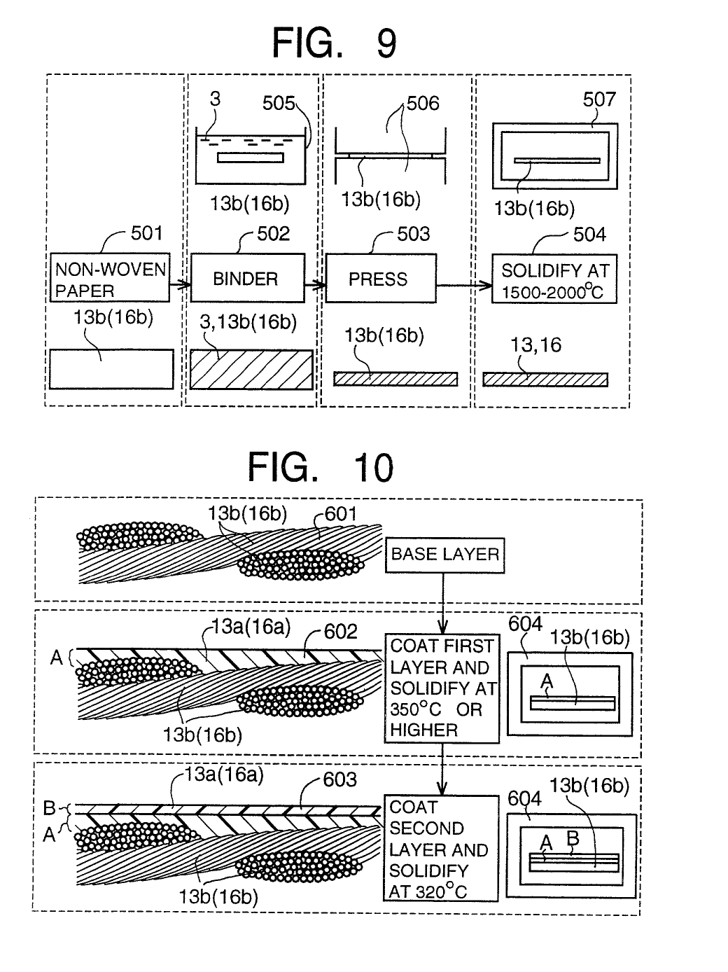

As illustrated in FIG. 9, the diffusion layer 13, 16 for the fuel cell according to the fifth embodiment of the present invention includes a non-woven base layer 13b, 16b made in a dry condition and a synthetic resin binder 3 (for example, pitch) impregnated into an entire range of the base layer 13b, 16b. The base layer 13b, 16b and the impregnated binder 3 are pressed and then completely carbonized.

As illustrated in FIG. 9, a method for manufacturing the diffusion layer 13, 16 for a fuel cell according to the fifth embodiment of the present invention includes: manufacturing a non-woven base layer 13b, 16b as a precursor in a dry condition at step 501, impregnating the non-woven base layer 13b, 16b with a synthetic resin binder 3 dissolved in solvent at step 502, pressing the base layer 13b, 16b impregnated with the synthetic resin binder 3 at step 503, and completely carbonizing the base layer 13b, 16b and the synthetic resin binder 3 impregnated into the base layer at step 504.

As illustrated in FIG. 9, an apparatus for manufacturing the diffusion layer 13, 16 for a fuel cell according to the fifth embodiment of the present invention includes: (a) a synthetic resin binder impregnating device 505 for impregnating a non-woven base layer 13b, 16b made in a dry condition with a synthetic resin binder 3, (b) a press device 506 for pressing the base layer 13b, 16b impregnated with the synthetic resin binder 3, and (c) a carbonizing furnace 507 for completely carbonizing the base layer 13b, 16b and the synthetic resin binder 3 impregnated into the base layer.

Though the dry non-woven precursor has a good productivity, (i.e., can be produced continuously and at a low cost and therefore, a prospective material for the base layer of the diffusion layer) it has an excessive cushion and a low strength and therefore, there is a problem that it is likely to creep.

To suppress the creep, in the fifth embodiment of the present invention, a compression load is imposed on the carbon fibers to make the carbon fibers creep beforehand, and using the carbon fibers which have crept as the material for the base layer, the diffusion layer 13, 16 having creep resistance is manufactured.

However, if the carbon fibers are pressed after having carbonized the carbon fibers, the carbon fibers will be broken when pressed. Therefore, the dry non-woven paper is manufactured from a precursor or insufficiently carbonized fibers, and then it is impregnated with the binder and is pressed, before it is completely carbonized.

Due to impregnation of the binder, the creep resistance of the base layer of the diffusion layer is improved and the diffusion layer can be produced at a low cost. Furthermore, as illustrated in FIG. 6, an increase in the internal electric resistance of the fuel cell is suppressed in the fifth embodiment similar to the first embodiment.

The above-mentioned first to fifth embodiments relate to an improvement of the creep resistance of the base layer of the diffusion layer, while the following sixth to last embodiments relate to an improvement of the creep resistance of the water-repellent layer of the diffusion layer.

Sixth Embodiment

As illustrated in FIG. 10, a diffusion layer for a fuel cell according to the sixth embodiment of the present invention includes (a) a base layer 13b, 16b having opposite surfaces and carbonized, and (b) a water-repellent layer 13a, 16a made from a mixture of carbon and synthetic resin (having water repellent, for example, PTFE (polytetrafluoroethylene)) formed on one surface of the base layer 13b, 16b. The water-repellent layer 13a, 16a is constructed of a multi-layer structure including an inner layer (A) and an outer layer (B) different in adhesiveness and strength to each other. The inner layer (A) has a strength greater than a strength of the outer layer (B).

The outer layer (B) has an adhesiveness stronger than an adhesiveness of the inner layer (A). The water-repellent layer 13a, 16a is non-carbonized. A thickness of the diffusion layer 13, 15 is about 200 μm and a thickness of the water-repellent layer 13a, 16a is 50-100 μm. A thickness of the outer layer (B) is about 10 μm.

The inner layer (A) and the outer layer (B) may be made from the same mixture of carbon and synthetic resin or the mixture ratio may be different between the inner layer (A) and the outer layer (B). The mixture is coated and solidified two times, and the solidifying temperature is changed for the inner layer and the outer layer. When the mixture is burned (melted and cooled to be solidified) at a temperature higher than about 350° C., it bulks and becomes rigid. When the mixture is burned at a temperature near the melting temperature of the synthetic resin (for example, at about 320° C., the half-melted synthetic resin particle is deformed into a filament to generate an adhesiveness. When the diffusion layer is assembled to a fuel cell, the adhesive layer is directed so as to face the catalyst layer of the electrode.

As illustrated in FIG. 10, a method for manufacturing a diffusion layer for a fuel cell according to the sixth embodiment of the present invention includes repeating a plurality of times a process comprising the steps of coating a layer made from a mixture of carbon and synthetic resin and then solidifying the layer, where the solidifying condition (for example, the solidifying temperature) is made different between respective processes.

More particularly, the method includes manufacturing a woven or non-woven base layer 13b, 16b from carbon fibers at step 601, coating a first water-repellent layer 13a, 16a made from a mixture of carbon and synthetic resin (for example, PTFE, phenolic resin, etc.) on the carbon base layer 13b, 16b and then solidifying the first water-repellent layer 13a, 16a at a first temperature (for example, 350° C.) higher than a melting temperature of the synthetic resin at step 602, and coating a second water-repellent layer 13a, 16a made from a mixture of the carbon and the synthetic resin on the first water-repellent layer and then solidifying the second water-repellent layer at a second temperature (for example, 320° C.) near the melting temperature of the synthetic resin at step 603.

As illustrated in FIG. 10, an apparatus for manufacturing the diffusion layer 13, 16 for a fuel cell includes a furnace 604 for solidifying a first water-repellent layer (A) made from a mixture of carbon and synthetic resin coated on a carbon base layer at a first temperature (for example, 350° C.) higher than a melting temperature of the synthetic resin and for solidifying a second water-repellent layer (B) made from a mixture of the carbon and the synthetic resin coated on the first water-repellent layer at a second temperature (for example, 320° C.) near the melting temperature of the synthetic resin. The furnace 604 can be used for forming the first, inner layer (A) and the second, outer layer (B) by changing the solidifying temperatures.

The mechanical characteristic of the water-repellent layer varies according to the burning temperature, because the melting state of the synthetic resin changes. More particularly, when the burning is conducted at a temperature near the melting temperature of the synthetic resin, the PTFE particle is not completely melted, and therefore, the particles are bound together at the contact points only. In such a state, when some load acts on the PTFE particle, the PTFE particle is easily deformed into a filament (to draw a filament) and generates adhesiveness. When the burning is conducted at a temperature higher than the melting temperature of the synthetic resin, the PTFE particles are completely melted into bulk and is no longer capable of being deformed into a filament, and the adhesiveness is lost.

The characteristics required for the diffusion layer include strength (creep resistance) and adhesiveness of the surface of the diffusion layer to the catalyst layer. It is difficult to achieve these two characteristics at the same time in the conventional art. However, in the sixth embodiment of the present invention, it becomes possible to achieve these two characteristics by burning the first layer (A) at a high temperature (for example, 350° C.) to obtain the high rigidness and burning the second layer (B) at a relatively low temperature (for example, 320° C.) to obtain the adhesiveness of the surface.

The kind of the mixture may be the same for the two layers (A) and (B). However, the kind of the mixture may be changed between the layers (A) and (B) in order to obtain a larger effect. More particularly, in order to increase the strength of the inner layer (A), it is effective to increase the ratio of PTFE in the mixture, while in order to increase the adhesiveness of the outer layer (B), it is effective to decrease the ratio of PTFE in the mixture.

Further, as illustrated in FIG. 6, an increase in the internal electric resistance of the fuel cell is suppressed in the sixth embodiment similar to the first embodiment.

Seventh Embodiment

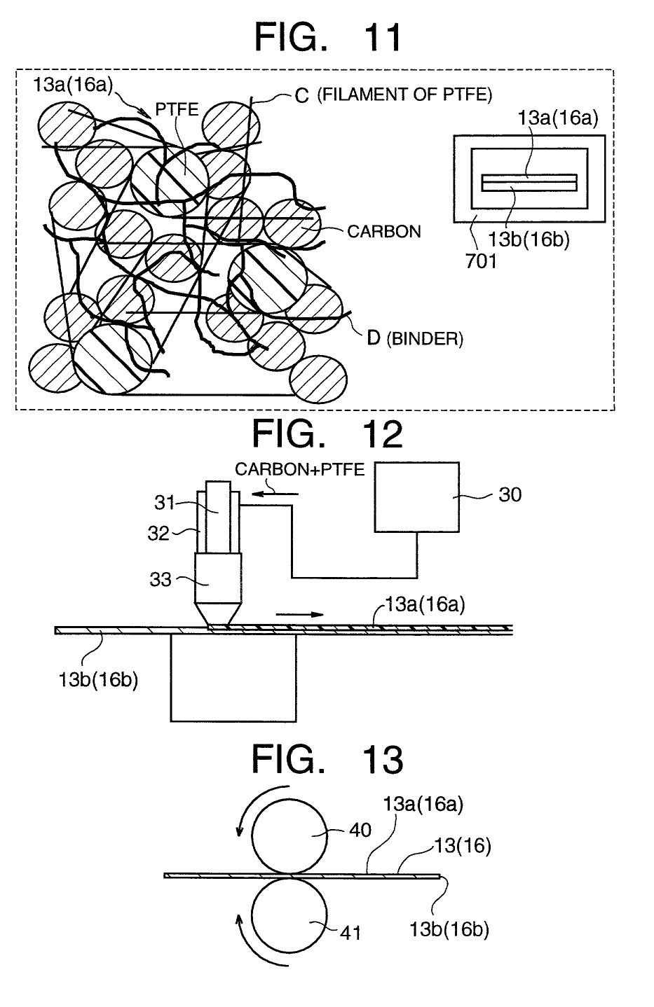

As illustrated in FIG. 11, a diffusion layer for a fuel cell according to the seventh embodiment of the present invention includes (a) a base layer 13b, 16b carbonized, and (b) a water-repellent layer 13a, 16a formed on one side of the base layer and including two kinds of binders. The water-repellent layer 13a, 16a includes carbon (for example, carbon black) and binders (for example, synthetic resin, cellulose) including two kinds of binders. The two kinds of binders include a first binder (C) made from a synthetic resin having an adhesiveness (for example, PTFE) and a second binder (D) made from material (for example, cellulose) having a higher rigidness than the synthetic resin of the first binder. The two kinds of binders which are dissolved in solvent (for example, ethanol) and are in the form of liquid or slurry, are coated onto the base layer 13b, 16b and are solidified at a temperature (about 320° C.) near the melting temperature of the synthetic resin.

As illustrated in FIG. 11, a method for manufacturing the water-repellent layer 13a, 16a of a diffusion layer 13, 16 for a fuel cell according to the seventh embodiment of the present invention includes: coating a mixture of carbon and two kinds of binders (C) and (D) on a base layer 13b, 16b of the diffusion layer, and solidifying the mixture coated on the base layer at a temperature near a melting temperature of one of the binders. The two kinds of binders includes a first binder (C) made from a synthetic resin having an adhesiveness (for example, PTFE) and a second binder (D) made from material having a greater rigidness than the first binder (for example, soluble cellulose).

As illustrated in FIG. 11, an apparatus for manufacturing the diffusion layer 13, 16 for a fuel cell includes a furnace 701 for solidifying a water-repellent layer 13a, 16a made from a mixture of carbon and two kinds of binders (C) and (D) and coated on the base layer 13b, 16b of the diffusion layer 13, 16 at a temperature (320° C.) near a melting temperature of one of the two kinds of binders.

Though PTFE is a resin having a relatively low rigidness, by adding a material having a relatively high rigidness (for example, cellulose) to PTFE, the strength and creep resistance of the water-repellent layer 13a, 16a can be increased.

Furthermore, as illustrated in FIG. 6, an increase in the internal electric resistance of the fuel cell is suppressed in the seventh embodiment similar to the first embodiment.

Eighth Embodiment

As illustrated in FIG. 12, a diffusion layer for a fuel cell according to the eighth embodiment of the present invention includes (a) a base layer 13b, 16b which is carbonized, and (b) a water-repellent layer 13a, 16a coated on the base layer. The water-repellent layer 13a, 16a is made from a mixture of carbon (for example, carbon black) and synthetic resin (for example, PTFE) and is solidified. The synthetic resin is deformed into filaments by applying a shear force to the mixture before the mixture in the form of a paste is coated onto the base layer 13b, 16b.

As illustrated in FIG. 12, a method for manufacturing the diffusion layer 13, 16 for a fuel cell according to the eighth embodiment of the present invention includes: applying a shear force to a paste including carbon and synthetic resin (for example, fluororesin such as PTFE) at a first step, coating the paste to which the shear force has been applied, onto a base layer 13b, 16b of the diffusion layer at a second step, and solidifying the paste (which becomes a water-repellent layer 13a, 16a after solidified) coated on the base layer at a temperature near the melting temperature of the synthetic resin at a third step.

As illustrated in FIG. 12, an apparatus for manufacturing the diffusion layer 13, 16 for a fuel cell according to the eighth embodiment of the present invention includes (a) a mixer 31 for applying a shear force to a paste including carbon and synthetic resin, (b) a coating device 33 for coating the paste on a base layer 13b, 16b carbonized of the diffusion layer 13, 16, and a furnace for solidifying the paste coated on the base layer at a temperature near the melting temperature of the synthetic resin. The furnace is similar to that of the former embodiments of the present invention.

The first step is conducted, in FIG. 12, by providing the paste from the main container 30 by the mixer 31, wherein when mixing the paste, a shear force is applied to the paste. Given the shear force, the paste generates an adhesiveness. In order to deform the resin particles into filaments, it is preferable that a heater 32 for heating the mixer 31 is provided around the mixer 31. The burning at the third step is conducted at, for example, 320° C.

Due to a shear force, PTFE particles are deformed into filaments so that the strength and creep resistance thereof are increased. Furthermore, as illustrated in FIG. 6, an increase in the internal electric resistance of the fuel cell is suppressed in the eighth embodiment similar to the first embodiment.

Ninth Embodiment

As illustrated in FIGS. 13 and 14, a diffusion layer 13, 16 for a fuel cell according to the ninth embodiment of the present invention includes (a) a base layer 13b, 16b which is carbonized, and (b) a water-repellent layer 13a, 16a coated on the base layer. The water-repellent layer 13a, 16a is made from a mixture of carbon (for example, carbon black) and synthetic resin (for example, PTFE). The mixture in the form of a paste is coated on the base layer and is solidified at a temperature near the melting temperature of the synthetic resin. After the synthetic resin is solidified and while the synthetic resin is at a temperature between the melting temperature and the ambient temperature or at the ambient temperature, a shear force is applied to the synthetic resin and at least a portion of the synthetic resin particles are deformed into filaments whereby the strength and creep resistance of the synthetic resin is increased.

As illustrated in FIGS. 13 and 14, a method for manufacturing the diffusion layer 13, 16 for a fuel cell according to the ninth embodiment of the present invention includes (a) coating a paste including carbon and synthetic resin for a water-repellent layer 13a, 16a on a base layer 13b, 16b of the diffusion layer 13, 16, (b) solidifying the paste coated on the base layer 13b, 16b at a temperature near the melting temperature of the synthetic resin, and (c) applying a shear force to the water-repellent layer 13a, 16a by causing the base layer 13b, 16b and the water repellent layer 13a, 16a to pass between a pair of rollers 40 and 41 which generate a stress directed across the width of the base layer, in the water-repellent layer 13a, 16a.

As illustrated in FIGS. 13 and 14, an apparatus for manufacturing the diffusion layer 13, 16 for a fuel cell according to the ninth embodiment of the present invention includes (a) a coating device (similar to the device 33 of FIG. 12) for coating a paste including carbon and synthetic resin (for example, PTFE) on a base layer 13b, 16b of the diffusion layer 13, 16, (b) a furnace (similar to the furnace of the former embodiments of the present invention) for solidifying the paste coated on the base layer at a temperature near the melting temperature (for example, 320° C.) of the synthetic resin, and (c) a pair of rollers 40 and 41 for applying a shear force to the paste solidified when the solidified paste and the base layer are caused to pass between the pair of rollers 40 and 41.

Each of the pair of rollers 40 and 41 has a spiral groove. When the pair of rollers 40 and 41 are rotated, the rollers apply a shear force to the diffusion layer between the rollers. The shear force is directed across the width of the diffusion layer.

Due to the shear force, PTFE particles are deformed into filaments so that the strength and creep resistance thereof are increased. Furthermore, as illustrated in FIG. 6, an increase in the internal electric resistance of the fuel cell is suppressed in the ninth embodiment similar to the first embodiment.

Although the present invention has been described with reference to specific exemplary embodiments, it will be appreciated by those skilled in the art that various modifications and alterations can be made to the particular embodiments shown without materially departing from the novel teachings and advantages of the present invention. Accordingly, it is to be understood that all such modifications and alterations are included within the spirit and scope of the present invention as defined by the following claims.

What is claimed is:

1. A diffusion layer for a fuel cell comprising at least a base layer, wherein said base layer only is increased in strength.

2. A method for manufacturing a diffusion layer including at least a base layer for a fuel cell comprising the steps of:
providing said base layer,
wherein said base layer only is increased in strength during providing the base layer.

3. An apparatus for manufacturing a diffusion layer including at least a base layer for a fuel cell comprising:
a device for providing a base layer,
wherein said base layer only is increased in strength.

4. A diffusion layer for a fuel cell comprising:
a base layer; and
a water-repellent layer coated on said base layer,
wherein only either one of said base layer and said water-repellent layer is increased in strength.

5. A diffusion layer according to claim 4, wherein said water-repellent layer only is increased in strength.

6. A method for manufacturing a diffusion layer for a fuel cell comprising the steps of;
providing a base layer; and
coating a water-repellent layer on said base layer,
wherein only either one of said base layer and said water-repellent layer is increased in strength during a respective one of said bas layer providing step and said water-repellent layer coating step.

7. A method for according to claim 6, wherein said water-repellent layer only is increased in strength during said water-repellent layer coating step.

8. An apparatus for manufacturing a diffusion layer for a fuel cell comprising:
a first device for providing a base layer; and
a second device for coating a water-repellent layer on said base layer,
wherein only either one of said base layer and said water-repellent layer is increased in strength by a respective one of said first device and said second device.

9. An apparatus according to claim 8, wherein said water-repellent layer only is increased in strength by said second device.

10. A diffusion layer for a fuel cell comprising:
a base layer,
said base layer including: (a) a carbonized yarn of a woven fabric, and (b) a carbonized binder impregnated into the yarn thereby connecting filaments of the yarn.

11. A method for manufacturing a diffusion layer for a fuel cell comprising the steps of:
impregnating a base layer constructed of a woven fabric with a synthetic resin binder; and
carbonizing said base layer and said binder impregnated into said base layer.

12. An apparatus for manufacturing a diffusion layer for a fuel cell comprising:
a binder impregnation treatment container for containing a dissolved binder to be impregnated into a base layer constructed of a woven fabric; and
a carbonizing furnace for carbonizing the base layer and the binder impregnated into the base layer.

13. A diffusion layer for a fuel cell comprising:
a base layer,
said base layer including: (a) a carbonized yarn constructed of a woven fabric, and (b) a conductive synthetic resin binder impregnated into the carbonized yarn thereby connecting filaments of the yarn, said binder being solidified and non-carbonized.

14. A method for manufacturing a diffusion layer for a fuel cell comprising the steps of:
carbonizing a base layer constructed of a woven fabric;
impregnating the carbonized base layer with a conductive synthetic resin binder; and
solidifying said conductive synthetic resin binder impregnated into said base layer.

15. An apparatus for manufacturing a diffusion layer for a fuel cell comprising:
a carbonizing furnace for carbonizing a base layer constructed of a woven fabric;
a binder impregnation treatment container for containing a dissolved conductive synthetic resin binder to be impregnated into said carbonized base layer; and
a furnace for solidifying said binder.

16. A diffusion layer for a fuel cell comprising:
a base layer having a water-repellent characteristic,
said base layer including: (a) a carbonized yarn constructed of a woven fabric, and (b) a non-conductive synthetic resin binder impregnated into the carbonized yarn thereby connecting filaments of the yarn, said binder being solidified and non-carbonized.

17. A method for manufacturing a diffusion layer for a fuel cell comprising the steps of:
carbonizing a base layer constructed of a woven fabric;
impregnating the carbonized base layer with a non-conductive synthetic resin binder selected from a group consisting of fluororesin and silicone resin; and
solidifying said non-conductive synthetic resin binder impregnated into said base layer.

18. An apparatus for manufacturing a diffusion layer for a fuel cell comprising:
a carbonizing furnace for a base layer constructed of a woven fabric;
a binder impregnation treatment container for containing a dissolved non-conductive synthetic resin binder to be impregnated into the carbonized base layer; and
a furnace for solidifying the binder.

19. A diffusion layer for a fuel cell comprising:
a base layer,
said base layer including: (a) a non-woven carbon paper made from carbon fibers, and (b) a synthetic carbonized resin binder impregnated into the carbon paper with a nonuniform distribution in an impregnation amount, wherein a first portion of said base layer including a relatively large amount of the binder is impregnated constructing a rigid portion of said base layer and a second portion of said base layer including a relatively small amount of the binder is impregnated constructing a deformable portion of said base layer.

20. A method for manufacturing a diffusion layer for a fuel cell comprising the steps of:
impregnating a base layer of a non-woven carbon paper made from carbon fibers in a wet condition with a synthetic resin binder so that said binder has a nonuniform distribution in an impregnation amount; and
carbonizing said binder impregnated into said base layer.

21. An apparatus for manufacturing a diffusion layer for a fuel cell comprising:
a synthetic resin binder impregnating device for impregnating a base layer of a non-woven carbon paper made from carbon fibers in a wet condition with a synthetic resin binder so that said binder has a nonuniform distribution in an impregnation amount; and
a carbonizing furnace for carbonizing said binder impregnated into said base layer.

22. A diffusion layer for a fuel cell comprising:
a non-woven base layer made in a dry condition and a synthetic resin binder impregnated into an entire range of said base layer, said base layer and said impregnated binder being pressed and then completely carbonized.

23. A method for manufacturing a diffusion layer for a fuel cell comprising the steps of:
impregnating a non-woven base layer made in a dry condition with a synthetic resin binder;
pressing said base layer impregnated with said synthetic resin binder; and
carbonizing completely said base layer and said synthetic resin binder impregnated into said base layer.

24. An apparatus for manufacturing a diffusion layer for a fuel cell comprising:
a synthetic resin binder impregnating device for impregnating a non-woven base layer made in a dry condition with a synthetic resin binder;
a press device for pressing said base layer impregnated with said synthetic resin binder; and
a carbonizing furnace for completely carbonizing said base layer and said synthetic resin binder impregnated into said base layer.

25. A diffusion layer for a fuel cell comprising:
a base layer having opposite surfaces; and
a water-repellent layer made from a mixture of carbon and synthetic resin formed on one surface of said base layer, said water-repellent layer being constructed of a multi-layer structure including an inner layer and an outer layer different in adhesiveness and strength to each other, said inner layer having a strength greater than a strength of said outer layer, said outer layer having an adhesiveness stronger than an adhesiveness of said inner layer.

26. A method for manufacturing a diffusion layer for a fuel cell comprising the steps of:
repeating a plurality of times a process comprising the steps of:
coating a layer made from a mixture of carbon and synthetic resin; and
solidifying said layer, a solidifying condition being different between respective processes.

27. The method according to claim 26, further comprising the steps of:
coating a first water-repellent layer made from a mixture of carbon and synthetic resin on a carbon base layer and then solidifying said first water-repellent layer at a first temperature higher than a melting temperature of said synthetic resin; and
coating a second water-repellent layer made from a mixture of said carbon and said synthetic resin on said first water-repellent layer and then solidifying said second water-repellent layer at a second temperature near said melting temperature of said synthetic resin.

28. An apparatus for manufacturing a diffusion layer for a fuel cell comprising:
a furnace for solidifying a first water-repellent layer made from a mixture of carbon and synthetic resin coated on a carbon base layer at a first temperature higher than a melting temperature of said synthetic resin and for solidifying a second water-repellent layer made from a mixture of said carbon and said synthetic resin coated on said first water-repellent layer at a second temperature near said melting temperature of said synthetic resin.

29. A diffusion layer for a fuel cell comprising:
a water-repellent layer including two kinds of binders.

30. The diffusion layer according to claim 29, wherein said two kinds of binders include a first binder made from a synthetic resin having an adhesiveness and a second binder made from material having a higher rigidness than said synthetic resin of said first binder.

31. A method for manufacturing a water-repellent layer of a diffusion layer for a fuel cell comprising the steps of:
coating a mixture of carbon and two kinds of binders dissolved in solvent on a base layer of said diffusion layer; and
solidifying said mixture coated on said base layer at a temperature near a melting temperature of one of said binders.

32. The method according to claim 31, wherein the coating step further comprises:
coating said mixture including said two kinds of binders on said base layer of said diffusion layer, said two kinds of binders including a first binder made from a synthetic resin having an adhesiveness and a second binder made from material having a greater rigidness than said first binder; and the solidifying step further comprises:
solidifying said mixture coated on said base layer at a temperature near a melting temperature of said first binder.

33. An apparatus for manufacturing a diffusion layer for a fuel cell comprising:
a furnace for solidifying a water-repellent layer made from a mixture of carbon and two kinds of binders and coated on a base layer of said diffusion layer at a temperature near a melting temperature of one of said two kinds of binders.

34. A diffusion layer for a fuel cell comprising:
a base layer; and
a water-repellent layer coated on said base layer, said water-repellent layer being made from a mixture of carbon and synthetic resin and solidified, said synthetic resin being deformed into filaments by applying a shear force to said mixture before coating of said mixture onto said base layer.

35. A method for manufacturing a diffusion layer for a fuel cell comprising the steps of:
applying a shear force to a paste including carbon and synthetic resin;
coating said paste on a base layer of said diffusion layer; and
solidifying said paste coated on said base layer at a temperature near a melting temperature of said synthetic resin.

36. An apparatus for manufacturing a diffusion layer for a fuel cell comprising:
a mixer for applying a shear force to a paste including carbon and synthetic resin;
a coating device for coating said paste on a base layer of said diffusion layer; and
a furnace for solidifying said paste coated on said base layer at a temperature near a melting temperature of said synthetic resin.

37. A diffusion layer for a fuel cell comprising:
a base layer; and
a water-repellent layer coated on said base layer, said water-repellent layer being made from a mixture of carbon and synthetic resin and solidified, said synthetic resin being deformed into filaments by applying a shear force to said water-repellent layer after solidifying said water-repellent layer.

38. A method for manufacturing a diffusion layer for a fuel cell comprising the steps of:
coating a paste for a water-repellent layer on a base layer of said diffusion layer, said paste including carbon and synthetic resin;
solidifying said paste coated on said base layer at a temperature near a melting temperature of said synthetic resin, and
applying a shear force to said water-repellent layer by causing said base layer and said water-repellent layer to pass between a pair of rollers which generate a stress directed in a width direction of said base layer in said water-repellent layer.

39. An apparatus for manufacturing a diffusion layer for a fuel cell comprising:
a coating device for coating a paste including carbon and synthetic resin on a base layer of said diffusion layer;
a furnace for solidifying said paste coated on said base layer at a temperature near a melting temperature of said synthetic resin; and
a pair of rollers for applying a shear force to the paste solidified when said solidified paste and said base layer are caused to pass between said pair of rollers.
